(19) United States
(12) Patent Application Publication
(10) Pub. No.: US 2005/0018620 A1
(43) Pub. Date: Jan. 27, 2005

(54) Method and arrangement for registering a terminal device on a communications node

(76) Inventors: Stefan Berndt, Bonen (DE); Thomas Hanna, Detmold (DE); Thorsten Laux, Paderborn (DE); Steffen Rusitschka, Munchen (DE); Christian Scheering, Bielefeld (DE); Alan Southall, Munchen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/855,022

(22) Filed: May 27, 2004

(30) Foreign Application Priority Data
May 28, 2003 (DE) 10324372.0

(51) Int. Cl. H04L 12/28; H04L 12/403; H04L 12/42

(52) U.S. Cl. 370/254; 370/453

(57) ABSTRACT

The invention relates to a method and an arrangement for registering a terminal device (EG1, EG2) on a communications node (KN1, KN2) in a communications network. A plurality of communications nodes (KN1, KN2) are disposed in the communications network, and the terminal device (EG1, EG2) is registered with one of the communications nodes (KN1, KN2). In a first step, the communications nodes (KN1, KN2) and their access parameters are registered in an information memory (DB). The terminal device (EG1, EG2) then accesses the information memory (DB), whereupon the transfer of the access parameters of at least one of the communications nodes (KN1, KN2) to the terminal device (EG1, EG2) takes place. Finally, the terminal device (EG1, EG2) is registered using the obtained access parameters with the one of these communications nodes (KN1, KN2).

### CROSS REFERENCE TO RELATED APPLICATIONS

This application claims priority of German application No. 10324372.0 filed May 28, 2003 and which is incorporated by reference herein in its entirety.

### FIELD OF INVENTION

The invention relates to a method for registering a terminal device on a communications node, and an arrangement to carry out the method.

### BACKGROUND OF INVENTION

A multiplicity of terminal devices and a plurality of communications nodes are usually disposed in communications networks. In circuit-switched communications arrangements, for example in ISDN systems, each terminal device is permanently registered in each case on one communications node (switching device) and is therefore permanently allocated. This allocation is determined by the cabling, so that a terminal device, for example a telephone or fax machine, is registered precisely on the switching device to which this terminal device is also physically connected. Cordless terminal devices are also registered in each case with a specific communications node, even if they temporarily use other communications nodes as a “guest”; this procedure is also known as “roaming”.

The terminal devices in voice data networks, frequently referred to as Voice-over-IP networks (VoIP=Voice-over-Internet-Protocol) are also permanently allocated to and registered with one of the communications nodes in the relevant voice data network. However, in a voice data network, every network component, i.e. every terminal device and every communications node, can essentially exchange data (in particular voice data) with every other network component. A permanent allocation of the network components to one another, as determined on the basis of the cabling in circuit-switched communications networks, is neither mandatory nor desirable. The terminal devices in voice data networks are also frequently referred to as “Clients”, because these terminal devices differ significantly from circuit-switched terminal devices. Thus, for example, they can be designed as a telephone with a network connection or as a computer on which communications software is installed. Since the clients in voice data networks can essentially exchange user information, i.e. voice data, directly with one another, the function of the communications node in such communications networks primarily entails connection control. Such instances are known in voice data networks (depending on the VoIP standard used) as a “Gatekeeper” (in accordance with H.323) or as a “Proxy” (in accordance with SIP, Session Initiation Protocol), since the function of these communications nodes entails not only connection initiation between the clients, but also access control to transmission devices to other networks, referred to as “Gateways”. The decision as to which client uses which communications node in a voice data network can be retaken as often as required, since manual adaptation of the cabling, i.e. the physical allocation, is no longer required and the “changeover” of a terminal device from one communications node to another communications node is effected entirely through a deregistration and subsequent registration procedure. In the commissioning of a voice data network or a terminal device in a voice data network, the registration of the terminal device which is to be newly installed is carried out manually at least once in one of the available communications nodes.

In the known methods and arrangements for registering a terminal device on a communications node, it has proved disadvantageous that high, and therefore also high-cost, outlay is incurred through the manual allocation between terminal devices and communications nodes and the associated manual registration procedures. In addition, such outlay must be incurred not only in the initial commissioning of a communications network, but is also incurred with each change in the structure of the communications network. This is the case, for example, when a terminal device is added to or removed from the communications network, in the event of replacement or failure of a communications node, or when a terminal device is moved from one communications node to another communications, node. The last-mentioned replacement is frequently carried out, for example, for evenly distributed utilization among the individual communications nodes.

### SUMMARY OF INVENTION

The object of the invention is to propose a method with which the outlay incurred in configuring a communications node is reduced, and to propose an arrangement in which the allocation of the terminal devices to communications nodes entails little manual outlay.

The object is achieved by the claims.

For the method, the solution provides that the communications nodes and their access parameters are initially registered in an information memory. The terminal device then accesses the information memory and the access parameters of at least one of the communications nodes are then transferred to the terminal device. Finally, the terminal device is registered with one of these communications nodes using the parameters obtained. Through the registration of the communications nodes and their access parameters in the information memory and the transfer of these access parameters to the terminal device, the terminal device can register with one of the communications nodes with no further manual intervention on the part of a user.

For the arrangement, the solution provides that an information memory, in which the communications nodes are registered with the relevant access parameters, is disposed in the communications network. The terminal device comprises means for accessing the information memory, whereby the access parameters of suitable communications nodes can be retrieved by the terminal device from the information memory, and whereby the terminal device registers with one of the suitable communications nodes using the access parameters.

The method is advantageously designed by the characterizing features of dependent claims 2 to 14. The advantages described for the method also apply accordingly to the arrangement.

In cases in which a voice data network is used as the communications network and gatekeepers are used as communications nodes, the method can be used for conventional VoIP networks. This applies in particular to VoIP networks according to the H.323 and SIP standards, whereby in the latter the gatekeepers are also referred to as “Proxies” or “SIP Proxies”. In addition, the method can also be used for other VoIP standards which have functional equivalents to gatekeepers and proxies.

If a voice data terminal device or a computer equipped with a telephony function is used as the terminal device, the known conventional terminal devices of VoIP networks can be allocated in a simple manner to the communications nodes.

From the set of all registered communications nodes, the access parameters of the suitable communications nodes can be filtered out from the information memory in that, in step a), information relating to the communications protocols supported by the relevant communications node and/or information relating to the number of total relevant terminal devices which can be registered are recorded as access parameters. If, in step a), the access parameters comprise information relating to the number of terminal devices which can currently be registered, and if this information is regularly transmitted from the communications nodes in each case to the information memory, registration attempts of terminal devices in those communications nodes whose capacity is exhausted are reduced and/or avoided.

The transfer of access parameters of unsuitable communications nodes to the terminal device is avoided in that, in step b), a requirements profile of the terminal device is transferred to the information memory during the access procedure and, in step c), the access parameters of those communications nodes which match the requirements profile are transferred from the information memory to the terminal device.

The transferred access parameters are available in the terminal device for further registration procedures, if the access parameters transferred in step c) are stored by the terminal device.

If, in step d), the registration of the terminal device is carried out by the terminal device itself, the operation of a separate registration instance is not required in the communications network.

Redundancy in relation to the failure of a communications node or in relation to unsuccessful registration attempts is provided if, in step c), the access parameters of a plurality of communications nodes are transferred to the terminal device, and in that, step d), in those cases in which the registration of the terminal device with the first of these communications nodes was unsuccessful, is repeated in further communications nodes whose access parameters were stored in step c) until either a successful registration has taken place or all communications nodes with access parameters stored by the terminal device have been processed.

If, in cases in which all stored communications nodes have been processed and successful registration has not taken place in any of these communications nodes, the method is repeated starting with step b), communications nodes added to the communications network in the interim period, or communications nodes in which capacities have again become free, are located by the terminal device and are used for registration. This registration is advantageously carried out automatically, i.e. without manual intervention on the part of a user or administrator.

In communications networks in which automatic registration of terminal devices with communications nodes is not required, the allocation of the terminal devices to the communications nodes can be carried out by an instance, a service, specifically provided for this purpose. To do this, information relating to a plurality of terminal devices of the communications network is stored in a memory area of the information memory. The relevant allocation of the terminal devices to the communications nodes is carried out by the service using the communications nodes registered in the information memory in step a) and using the information relating to the terminal devices stored in the memory area. A preferred communications node is defined in each case for each of the terminal devices as a result of the allocation. The terminal devices are then registered in step d) in each case with the allocated preferred communications node.

Failure of the communications node on which the terminal device is registered can be pre-empted by adding an additional method step e). This method step e) provides that the terminal device is registered on a further of the communications nodes whose access parameters were transferred in step c), if the communications node on which the terminal device is registered fails.

The function of a terminal device, for example authorizations, can be controlled through the registration of a user with the communications node on which the terminal device is registered.

A basic functionality, for example for emergency call purposes, of the terminal devices is guaranteed in that different users can be registered with different authorizations on the communications node. In step d), when the terminal device is registered, the user of this terminal device is additionally registered with the communications nodes. In that a standard user can be registered with a standard authorization on the communications nodes, and in that the terminal device is registered with the standard user on the communications node, provided that no other user is registered via this terminal device on the communications node, the terminal device can always be used with the usage scope which is defined for the standard user. This standard usage scope comprises at least the emergency call function.

Embodiments of the method according to the invention are explained below with reference to the drawing, and serve at the same time to explain an embodiment of the arrangement according to the invention.

### BRIEF DESCRIPTION OF THE DRAWING

The single FIGURE shows a schematic representation of a communications network with a data network, two communications nodes, two terminal devices and an information memory.

### DETAILED DESCRIPTION OF INVENTION

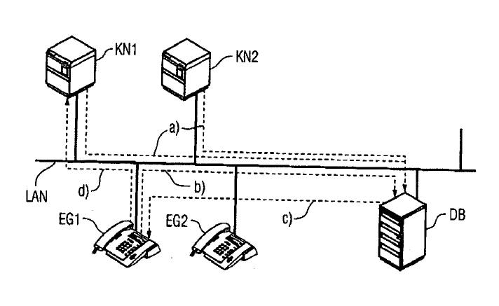

FIG. 1 shows a communications network in which communications nodes KN1, KN2, terminal devices EG1, EG2 and an information memory DB are disposed as components. These components communicate with one another using a data network LAN.

The data network LAN is an “IP network”, i.e. a network in which components exchange packet-switched data, in particular voice data, using the Internet Protocol (IP). Other transport media can of course also be used for the data instead of the data network LAN.

H.323 gatekeepers are used here as communications nodes KN1, KN2, which in each case form the registration instance for a number of H.323-supporting terminal devices EG1, EG2, and in addition perform further functions, which will not be further examined in the context of this embodiment. SIP proxies or communications nodes with similar functions can be used instead of the H.323 gatekeepers, if the SIP protocol or other communications protocols are used.

The terminal devices EG1, EG2 are VoIP telephones, i.e. telephony terminal devices designed for use in voice data networks. Computers (PCs) with telephony software (“soft phones”) or other communications devices with a voice data interface can of course also be used instead of the clients designed as telephony terminal devices. Of the terminal devices EG1, EG2 shown, the terminal device EG1 will be examined below as an example.

The information memory DB is a database which the components of the communications network can access. Although the information memory DB is shown in FIG. 1 as a separate device, the functionality of the information memory DB can also be performed by other network components. In particular, it is also possible for the information memory DB to be a “distributed” information memory DB, i.e. a database whose components are distributed among different network components. In the communications network, the information memory DB serves primarily to store data which are used to register the communications nodes KN1, KN2, and therefore to store the access parameters allocated to these communications nodes KN1, KN2. However, apart from this information, other information can also be stored in the information memory DB; this capability of the information memory DB is used in a further embodiment of the invention which will be described later.

In FIG. 1, the method steps for registering the terminal device EG1 with the communications node KN1 are symbolized by arrow lines; the lines are designated for this purpose by the reference letters a) to d).

The communications nodes KN1, KN2 register with their access parameters following activation (“run-up”) with the information memory DB. The access parameters of the communications nodes KN1, KN2 in each case comprise the network address of the communications nodes KN1, KN2 in the data network LAN, which were allocated in each case to the communication node KN1, KN2 following its activation. This allocation can be carried out statically or dynamically. Here, it is carried out dynamically according to the DHCP procedure (DHCP=Dynamic Host Configuration Protocol); this method is generally known and will not be further examined at this point. The transmitted access parameters furthermore comprise the information indicating how many terminal devices can be registered on the relevant communications node KN1, KN2, and how many terminal devices, with the current utilization of the communications nodes KN1, KN2 can in each case still be registered on said nodes.

The last-mentioned information relating to the amount of remaining registration capacity of course changes following each registration or deregistration of a terminal device EG1, EG2. This information is therefore retransferred at regular intervals from the communications nodes KN1, KN2 to the information memory DB. In the present case, the interval for these transfers is selected in such a way that said transfer takes place when the residual capacity remaining in the relevant communications node KN1, KN2 has changed by a specific threshold (in this example threshold is 10) compared with the last message. Other intervals, in particular also time intervals, can of course also be selected. Moreover, the information relating to the total capacity and the residual capacity of the communications nodes KN1, KN2 may be totally dispensed with, because, as in this example, with inadequate residual capacity, the registration of a terminal device EG1, EG2 is refused by the relevant communications node KN1, KN2 and consequently the affected terminal device EG1, EG2 carries out a registration attempt on a further of the communications nodes KN1, KN2.

All the communications nodes KN1, KN2 must of course have access to the information memory DB which is used. However, in contrast to the embodiment presented here, it is also possible for a plurality of information memories to be disposed in the communications network, and for the communications nodes KN1, KN2 to be allocated in each case to one of these information memories.

The registration process of the communications nodes KN1, KN2 is presented in FIG. 1 using the arrows designated with the reference letter a).

In the next method step, which is shown in FIG. 1 with the reference letter b), the terminal device EG1 sets up a connection to the information memory DB. To do this, the terminal device is equipped with a control unit which accesses a user interface of the information memory DB with an interface via the data network. During the access procedure, the terminal device EG1 transfers a requirements profile which describes the minimum requirements for one of the sought communications nodes KN1, KN2. This requirements profile comprises, for example, information relating to the required communications protocols (voice codecs), the minimum number of communications connections which can be administered, etc. To set up the connection to the information memory DB, the terminal device EG1, exactly as the communications nodes KN1, KN2, requires the network address of the information memory DB or, if a distributed information memory DB is involved, the network address of an entry point of the distributed information memory DB. This address can be stored by an administrator in the network components; however, in the present case, when the terminal devices EG1, EG2 or communications nodes KN1, KN2 are activated, the address of the information memory DB is transferred to said devices or nodes by means of additional information of the DHCP procedure.

In the present embodiment, it is assumed that the access parameters transferred in method step a) from the communications nodes KN1, KN2 to the information memory DB in each case meet the requirements of the requirements profile which was transferred in step b) from the terminal device EG1 to the information memory DB. Consequently, the information memory DB transfers the access parameters of both suitable communications nodes KN1, KN2 in method step c) to the terminal device EG1.

The terminal device EG1 then registers with the communications node KN1; the procedure is shown schematically in FIG. 1 by the arrow designated as d). For the registration, the control unit of the terminal device EG1 is equipped with software which carries out the registration in accordance with a protocol agreed in the data network; this is also referred to as an implemented “protocol stack”.

If the registration of the terminal device EG1 with the communications node KN1 fails in step d), because, for example, the communications node KN1 has reached its capacity limit or has failed in the interim period, the terminal device EG1 sets up a connection to a different communications node whose access parameters were transferred from the information memory DB in order to register with this alternative communications node. In the present example, this is the communications node KN2. However, this alternative method is possible only if, as in the present case, not only the access parameters of the communications node KN1, but also those of communications node KN2, have been stored in method step c) by the terminal device EG1.

The registration attempts are continued until either a successful registration with one of the communications nodes KN1, KN2 has taken place, or until all communications nodes KN1, KN2 whose access parameters were transferred in method step c) have been processed. Once the list of access parameters stored in the terminal device EG1 has been processed, the terminal device EG1 again sets up a connection to the information memory DB in order again to transmit a or the requirements profile and retrieve a list of access parameters of suitable communications nodes KN1, KN2. This occurs because, in the interim period, i.e. following the last retrieval of access parameters, for example, a further communications node not shown here may have been added to the communications network, or other changes may have occurred in the structure of the communications network.

If the communications node KN1 fails following a successful registration of the terminal device EG1, the terminal device EG1 attempts to register with the communications node KN2 whose access parameters were similarly transferred to the terminal device EG1 in method step c).

The total of all access parameters of the communications nodes KN1, KN2 registered in the information memory DB can be regarded as a first information set, referred to below as the PBX set. Analogous with the PBX set, a second information set, referred to below as the EP set, can also be stored in the information memory DB. The EP set (EP=End Points) comprises information relating to all terminal devices EG1, EG2 disposed in the communications network. Whereas, in the embodiment of the invention described above, the terminal device EG1 itself decides in which of the communications nodes KN1, KN2 a registration attempt is to be made, in the embodiment now being considered, an allocation service (not shown here) disposed in the communications network can make this decision. The allocation service can control the allocation of terminal devices EG1, EG2 to communications nodes KN1, KN2 from different perspectives, for example with the aim of evenly distributed utilization of the communications nodes KN1, KN2, or with the aim of preferred utilization of the least-cost communications node KN1, KN2, etc. As a result of this allocation, the allocation service defines a preferred communications node KN1, KN2 for each of the terminal devices EG1, EG2. It is assumed below that the communications node KN1 is the preferred communications node for the terminal device EG1.

The allocation service then transfers the access parameters of the preferred communications node KN1, KN2 to the terminal device EG1, whereupon the terminal device EG1 registers with the communications node KN1. Alternatively, the allocation service can itself also register the terminal device EG1 with the communications node KN1 and can transfer information to the terminal device EG1 indicating that it is then registered with the communications node KN1.

In a further embodiment of the communications network, not only terminal devices EG1, EG2, but also the users of the terminal devices EG1, EG2, register with the communications network KN1, KN2. The reason for this is, for example, the allocation of different authorizations to different users, whereby, for example, only selected users are allowed to use external communications connections which incur charges. Thus, for example, external telephone calls can only be made from a terminal device EG1 which is registered on the communications node KN1 if a user with the authorization to make external telephone calls is registered via the terminal device EG1 on the communications KN1. In order to meet the general requirement that emergency calls can be made from every functional terminal device EG1, EG2, the terminal device EG1 initially registers itself in method step d) as described, in order to register a “standard user” with the communications device KN1 in the same method step. At least the authorization to make emergency calls is allocated to this “standard user”. If a user with a different authorization registers at a later time via the terminal device EG1 with the communications node KN1, this “regular user” is linked in the communications node KN1 with the terminal device EG1 instead of the standard user, so that the terminal device EG1 thus attains its full functionality. If the “regular user” deregisters at a further later time via the terminal device EG1 from the communications node KN1, the standard user is once more allocated to the terminal device EG1.

1.-15. (cancelled)

16. A method for registering a terminal device on a communications node in a communications network, wherein the communications network having a plurality of communications nodes, the method comprising:
registering the communications nodes and their access parameters in an information memory;
accessing of the terminal device to the information memory;
transferring the access parameters of at least one of the communications nodes to the terminal device; and
registering the terminal device using the obtained access parameters with one of these communications nodes.

17. The method as claimed in claim 16, wherein a voice data network is used as the communications network, and gatekeepers are used as communications nodes.

18. The method as claimed in claim 17, wherein a voice data terminal device or a computer equipped with a telephony function is used as the terminal device.

19. The method as claimed in claim 16, wherein
in the registering the communications nodes and their access parameters step, information relating to the communications protocols supported by the relevant communications node and/or information relating to the number of total respective terminal devices which can be registered are recorded as the access parameters.

20. The method as claimed in claim 16, wherein
in the registering the communications nodes and their access parameters step, the access parameters comprise information relating to the number of terminal devices which can currently be registered, and this information is regularly transmitted from the communications node in each case to the information memory.

21. The method as claimed in claim 16, wherein
in the accessing step, a requirements profile of the terminal device is transferred to the information memory during the access procedure, and wherein
in the transferring step, the access parameters of those communications nodes which match the requirements profile are transferred from the information memory to the terminal device.

22. The method as claimed in claim 16, wherein the access parameters transferred in the transferring step are stored by the terminal device.

23. The method as claimed in claim 16, wherein
in the registering the terminal device step, the registration of the terminal device is carried out by the terminal device itself.

24. The method as claimed in claim 22, wherein
in the transferring step, the access parameters of a plurality of communications nodes are transferred to the terminal device, and wherein
in those cases in which the registration of the terminal device with a first of these communications nodes is unsuccessful, the registering the terminal device step is repeated in further communications nodes whose access parameters were stored in the transferring step, until either a successful registration has taken place or all communications nodes with access parameters stored by the terminal device have been processed.

25. The method as claimed in claim 24, wherein in cases in which all stored communications nodes have been processed and successful registration has not taken place in any of these communications nodes, the following steps are performed:
accessing of the terminal device to the information memory;
transferring the access parameters of at least one of the communications nodes to the terminal device; and
registering the terminal device using the obtained access parameters with one of these communications nodes

26. The method as claimed in claim 16, further comprising:
storing information relating to terminal devices of the communications network in a memory area of the information memory;
performing a relevant allocation of the terminal devices to the communications nodes by a service using the communications nodes registered in the information memory in the registering the communications nodes and their access parameters step and using the information relating to the terminal devices stored in the memory area;
defining as a result of the allocation to each of the terminal devices, a preferred communications node; and
performing the registration of the terminal devices in the registering the terminal device step with the allocated preferred communications node.

27. The method as claimed in claim 16, further comprising:
registering the terminal device on a further of the communications nodes whose access parameters were transferred in the transferring step if the communications node on which the terminal device is currently registered fails.

28. The method as claimed in claim 16, wherein the registration of a user on the communications node on which the terminal device is registered.

29. The method as claimed in claim 28, wherein
different users can be registered with different authorizations on the communications node, wherein
in the registering the terminal device step, when the terminal device is registered, the user of this terminal device is additionally registered with the communications node, wherein
a standard user can be registered with a standard authorization on the communications node, and wherein
the terminal device is registered with the standard user on the communications node, provided that no other user is registered via this terminal device on the communications node.

30. An arrangement for registering a terminal device on a communications node in a communications network, comprising:
an information memory operatively adapted in the communications network, for registering the communications nodes together with the relevant access parameters;
a mechanism for accessing the information memory; and
a mechanism for registering the terminal device with one of the suitable communications nodes using the access parameters, wherein
the access parameters of suitable communications nodes are retrieved by the terminal device from the information memory.

31. The arrangement as claimed in claim 30, wherein the mechanism for accessing the information memory is part of the terminal device.

32. The arrangement as claimed in claim 30, wherein the mechanism for registering the terminal device is part of the terminal device.
